(19) United States
(12) Patent Application Publication
(10) Pub. No.: US 2023/0244902 A1
(43) Pub. Date: Aug. 3, 2023

(54) Device, Method and Apparatus for Improving Processing Capabilities for Computer Visual Applications

(71) Applicant: INUITIVE LTD., Ra'anana (IL)

(72) Inventor: Yaron RASHI, The Hague (NL)

(21) Appl. No.: 17/586,280

(22) Filed: Feb. 3, 2022

(51) Int. Cl. G06N 3/04

(52) U.S. Cl. CPC G06N 3/04

(57) ABSTRACT

A method and a computational module are provided for carrying out a computer vision application, and comprising at least one processing means, wherein the computational module is characterized in that it has a systolic array architecture, configured to receive the conveyed information from the at least one image sensor and to apply Row Stationary dataflow for calculating convolutions in a Convolutional Neural Network (“CNN”).

### TECHNICAL FIELD

The present disclosure generally relates to devices, methods and apparatus for use in optical devices, and more particularly, for improving processing capabilities for computer visual applications.

### GLOSSARY

### ALU: Arithmetic Logic Unit

### BA: Basic Array

### CFU: Coefficient Feed Unit

### CNN: Convolutional Neural Networks

### FFU: Feature Feed Unit

### FIFO: First In First Out

### MA: Macro Array

MAC: multiply-accumulate

### NLR: No-Local-Reuse

### NOC: Network On Chip

### PE: Processing Element

### PPU: Post Processing Unit

### OS: Output Stationary

### RF: Register File

### RS: Row Stationary

### SA: Systolic Array

### SDRAM: Synchronous Dynamic Random Access Memory

### SPPA: Spatial Programable Processing Array

### TPU: Tensor Processing Unit

### VDP: Vector Dot-Product

### VDPP: Vector Dot-Product Pool

### VLSI: Very Large-Scale Integration

### WS: Weight Stationary

### BACKGROUND

In recent years an increasing number of computer vision applications that were historically relying on hand crafted processing methods, employ deep learning methods, such as Convolutional Neural Network (“CNN”). As a result, the CNN processing power requirements for computer vision applications has naturally increased significantly. In some cases, an edge device, like a robot or AR/VR glasses or a drone, would require tens to hundreds of tera multiply-accumulate (“MAC”) operations per seconds (i.e., 10¹³-10¹⁴ mac/sec) for CNN-based computer vision applications, wherein a multiply-accumulate operation is a common step that computes the product of two numbers and adds that product to an accumulator. Moreover, implementations for vehicles are likely to require even a higher number of MAC operations per seconds, as these implementations typically execute multiple computer vision tasks concurrently.

Two of the major challenges which edge devices are typically facing when supporting high throughput CNN applications, are, power consumption and Synchronous dynamic random-access memory (“SDRAM”) bandwidth.

Three main classes of CNN processor architectures are known in the art:

a) Vector Dot-Product Pool (“VDPP”), exemplified in FIG. 1.

By this implementation, convolutions are broken into multiple multiply-accumulate operations and can be represented by a sum of vector dot products (VDP). VDPP accelerators contain a pool of VDP units. A compiler is managing the breaking of convolutions into VDP operations. Data and coefficients are being fed into VDP units via buffers, and adders at the output of the VDP units are used for aggregating multiple VDP operations into full convolution calculations. There are different variants for this architecture (including for example, different VDP vector size, multiple output buffers that work with any single VDP unit, and the like).

b) Spatial Programable Processing Array (SPPA) which is exemplified in FIG. 2.

SPPA is composed of an array of simple programable processing elements connected together via on-chip-network. Data may be forwarded between processing elements or between processing elements and peripheral buffers.

The example illustrated in FIG. 2 is of an architecture that has been implemented in MIT's Eyeris project, for exploring different data flows. Eyeris architecture (as demonstrated in FIG. 2) is composed of an array of processing elements (“PEs”) and a multilevel storage hierarchy, including an off-chip DRAM, a global buffer, a network-on-chip (“NOC”), and a register file (“RF”) in the PE. The off-chip DRAM, global buffer, and PEs in the array may communicate with each other directly through the input and output FIFOs (“iFIFO” and “oFIFO”, respectively). Within each PE, the PE FIFO (pFIFO) controls the traffic going in and out of the arithmetic logic unit (“ALU”), including that from the RF or from other storage levels.

c) Systolic Arrays (“SA”). The third class of CNN processor architecture known in the art is SA which is a homogeneous network of tightly coupled processing elements. Each PE independently computes a partial result as a function of the data received from its upstream neighbors, stores the result within itself and passes it downstream. The parallel input data flows through a network of hard-wired processor nodes, combine, process, merge or sort the input data into a derived result.

Systolic Arrays are similar in some ways to SPPA, as they are also composed of an array of processing elements with inter connections. There are, however, several differences, between the two. First, the programmability level of each processing element used while implementing SA is very limited, unlike PE's in when SPPA is implemented. A PE in a SPPA will have a flexible ALU, large register file which may be used for different purposes, and rich set of instructions. A PE in a Systolic Array will have a few registers with dedicated purpose, and very limited ALU, which can carry out only a few functions. Second, when implementing SA, the connectivity between PE's is limited and hard wired. Each PE is able to send data to, and receive data from, one or few predefined neighbors. Third, the SA is designed for, and can support, a specific data flow (i.e., a specific way in which the high-level function, like convolution, is implemented). This is different from the SPPA implementation, as the latter can be configured to execute different data flows and perform different high-level tasks. Forth, when SA is implemented, the operation of each PE and data transfer between PE's are synchronized for all elements included in the array. One may consider that concept as similar to different components comprised in a mechanical engine, that perform their task in a specific timing with respect to other components. This is not necessarily the case for SPPA.

When analyzing power consumption of the different solutions, it is convenient to break the power consumption into that of each of the following consumers: arithmetic operations (mainly multiply-accumulate operations), access to local registers (i.e., registers close to the arithmetic unit), NOC transactions, access to global buffers and access to SDRAM. It has been shown that the power consumption of a single multiply-accumulate operation is similar to that of an access to a local register and also similar to a NOC transaction. It has also been shown that a global buffer access would consume about ten times more than a multiply-accumulate operation, and that an SDRAM access would consume about 100× more than the multiply-accumulate operation. One can conclude that in order to reduce the power consumption, one would need to increase data and coefficient reuse factor, where the latter is defined as the average number of multiply-accumulate operations for any single memory access.

A processing engine that is engaged in calculating a convolution, may be characterized by its data flow (i.e., how data is handled by the processing engine). For example, a Weight-Stationary (“WS”) dataflow keeps filter weights (or coefficients) stationary, near the arithmetic unit, by enforcing the following mapping rule: all (or many) MAC operations that use the same filter weight are mapped to the same arithmetic unit for being serially processed thereat, a technique which maximizes the reuse of weights in the local registers. Another example: an Output-Stationary (“OS”) dataflow keeps partial sums stationary by accumulating them locally in local registers. The mapping rule is that all MAC operations that generate partial sums for the same output pixel are mapped on the same arithmetic unit.

VDPP architectures are usually operated while having a combination of data-stationary, weight-stationary and output-stationary data flows. However, in all these data flows there is at least one component (mainly data or coefficients) that has to change every cycle (i.e., reuse factor=1) and thus the power consumption is at least 10-20 times higher than the power invested in the arithmetic calculation itself.

SPPA architecture can support multiple dataflows, such as matrix multiplication data flow as used in Google® Tensor Processing Unit (“TPU”) systolic array. In this case each programable processing element will support the same functionality as a systolic processing element in a TPU.

Y. H Chen et al., in their publication “Using Dataflow to Optimize Energy Efficiency of Deep Neural Network Accelerators”, IEEE Micro, Vol. 37, Issue 3, 2017 (hereinafter “[1]”) showed how other data flows, such as Weight-Stationary, Output-Stationary or Non-Local-Reuse can also be supported by an SPPA architecture. In [1], Y. H Chen et al. also proposed a new data flow that is referred to as a Row Stationary (“RS”) dataflow. They characterized the behavior of the RS dataflow with an SPPA platform they designed. In RS dataflow, each processing element calculates a 1D convolution, with kernel size ‘k’, as follows ( ):

$${Result}_{Out} = {Result}_{In} + {\sum }_{x = 1}^{k} {C}_{x} \cdot {D}_{x}$$

wherein Cx are the kernel's coefficients; and
Dx are the data features.

When calculating a 2D convolution, one has to arrange k processing elements, one above the other, where each PE delivers its result to the PE located above it.

A 2D convolution in a CNN architecture involves accumulating multiple input channels as indicated in the equation below. Every output feature is calculated by accumulating multiple 2D convolutions as follows (where C represent coefficients, D represent data features and B represent convolution bias):

$${O}_{u , x , y} = {B}_{u} + {\sum }_{z = 0}^{Number of input channelz - 1} {\sum }_{i = 0}^{k - 1} {\sum }_{j = 0}^{k - 1} {C}_{z , i , j} \cdot {D}_{z , x + i , y + j}$$

By placing several groups of k processing elements one above the other, one may calculate an output pixel of a 2D CNN convolution.

Every column (in a matrix of N×K processing elements) is responsible to calculate one output feature line. By placing multiple PE columns side by side, one may calculate multiple output lines concurrently. In this structure, input data features move diagonally from one PE to another, coefficients move horizontally from one PE to another and the partial sums' (i.e., the results) move vertically from one PE to another.

Let us consider now the following example: in order to calculate three output lines of a 2D convolution with a kernel=3 and a stride=1, an array of 3×3 processing elements, as shown in FIG. 4, is used. The following explanation demonstrates how one may have the marked data block, with the data features e1/f1/g1/e2/f2/g2/e3/f3/g3, convolved within three calculation cycles.

In the first calculation cycle, the bottom row of the marked block is convolved by the left bottom PE. The result is passed to the PE above. In the second calculation cycle the mid row of the marked block is convolved and added to the result obtained from the lower PE. The result is then passed to the PE above. In the third cycle, the top row of the marked block is convolved and added to the result from its preceding PE (which contains the sum of the two lower rows). The result thus obtained is the final convolution.

Now, let us consider a further example as depicted in FIG. 5. In order to calculate two output lines of a 2D convolution with kernel=3 and stride=2, one uses an array of 3×2 processing elements as shown in FIG. 5. The highlighted block is convolved within three calculation cycles. However, it should be noted that in this case (i.e., when stride=2) two features are loaded to each PE at each calculation cycle and the feature feed connectivity within the array is a little different than the case wherein the stride=1.

RS dataflow was shown to consume less power than WS, OS or NLR dataflows. However, the SPPA architecture is not exploiting the full power savings potential of the RS data flow as its processing elements and NOC are too complex and flexible and thus are not power optimized.

However, the present invention is intended to provide a solution that consumes less power and less SDRAM bandwidth from the solutions known in the art.

### SUMMARY OF THE DISCLOSURE

The disclosure may be summarized by referring to the appended claims.

It is an object of the present disclosure to provide a method and apparatus that implement an innovative systolic array architecture for the computation of CNN functions.

It is another object of the present disclosure to provide a method and apparatus that implement a VLSI-based, high throughput CNN engine, that consumes less energy and SDRAM bandwidth than other solutions of the art, wherein VLSI is the process of creating an integrated circuit by combining millions of MOS transistors onto a single chip.

It is still another object of the present disclosure to provide a method and apparatus for implementing an architecture that is suitable to achieve a reuse factor that is substantially larger than 1 for features, coefficients and partial sums. Such an architecture utilizes less power and less SDRAM bandwidth than VDPP architectures.

It is another object of the present disclosure to provide a method and apparatus for implementing an architecture that enables reducing system cost, size and heat generation.

It is still another object of the present disclosure to provide a method and apparatus for implementing an architecture that enables edge devices to support more complicated CNN applications (e.g., having higher processing power requirements).

Other objects of the present invention will become apparent from the following description.

According to a first embodiment of the disclosure, there is provided a computational module adapted to be used for carrying out a computer vision application and comprising at least one processing means (e.g., a processor), wherein the computational module is characterized in that it has a systolic array architecture and is configured to receive information conveyed from at least one image sensor and to apply Row-Stationary dataflow for calculating convolutions in a Convolutional Neural Network (“CNN”).

The term “computational module” as used herein throughout the specification and claims, is used to denote a a number of distinct but interrelated units for carrying out a computational process. Such computational modules can be an Application-Specific Integrated Circuit (“ASIC”), or a Field Programmable Gate Array (“FPGA”) or any other applicable processing device.

The term “image sensor” as used herein throughout the specification and claims, is used to denote a sensor that detects and conveys information used to make an image. Typically, it does so by converting the variable attenuation of light waves (as they pass through or reflect off objects) into signals. The waves can be light or another electromagnetic radiation. An image sensor may be used in robotic devices, AR/VR glasses, a drone, a digital camera, smart phones, medical imaging equipment, night vision equipment and the like.

According to another embodiment, there is provided a user device that comprises the computational module, at least one image sensor configured to convey information for generating an image.

In accordance with another embodiment, the at least one processing means comprises at least one macro array of processing elements, wherein each of the at least one macro array comprises a plurality of basic arrays of processing elements and wherein each of the plurality of basic arrays comprises a plurality of processing elements, each of the processing elements is a synchronous digital circuit, operated with a clock signal toggling at a pre-defined frequency, and the at least one macro array, the plurality of basic arrays and the plurality of processing elements are arranged in a layered hierarchical order.

According to another embodiment, the plurality of processing elements comprising each at least one data register, at least one coefficient register, at least one control register, at least one multiplier and at least one adder, and wherein each of the plurality of processing elements is configured to execute a part of the process for calculating convolutions in a CNN, depending on location of each respective processing elements within a corresponding basic array to which it belongs.

By yet another embodiment, the native convolutions supported by the architecture, comprise convolutions having a kernel=3 or a kernel=4, together with a stride=1 or a stride=2, and together with a dilation=1.

In accordance with still another embodiment, the native convolutions having a kernel=3 or a kernel=4, together with a stride=1 or a stride=2 and together with a dilation=1, are used to calculate convolutions with a kernel=3, 4, 5 or 7, together with a stride=1 or stride=2, and together with a dilation that is equal to 1, 2 or 3.

According to another embodiment, at least one from among the plurality of processing elements is adapted to output data belonging to more than one output channel, while reusing the same input data.

According to yet another embodiment the macro array is arranged in a plurality of rows and columns, each row comprises a plurality of basic arrays, and wherein all basic arrays included in a respective row of the macro array are fed with the same input feature stream via a single feature feed unit group, configured to forward features' related data for calculating CNN convolutions using the systolic array architecture.

In accordance with still another embodiment, the macro array is provided with a cache memory for storing features' related data and coefficients' related data thereat.

By yet another embodiment, all processing elements located along an edge of a respective basic array are connected to a single coefficient feed unit group, configured to forward coefficients' related data for all processing elements associated with said respective basic array.

According to another embodiment, the processing elements included in each of the plurality of basic arrays are arranged in a way that ensures a systolic operation of that user device.

In accordance with another embodiment, the processing elements are arranged in each of the plurality of basic arrays in a way that ensures connectivity between the processing elements that enables conveyance of data and control information in order to achieve the systolic operation of the user device.

By still another embodiment, results obtain from one neural network layer are stored back in the cache memory and used as inputs for one or more downstream layers without having to approach an external memory (e.g., an SDRAM) to retrieve required data therefrom.

According to another aspect of the disclosure there is provided a method for carrying out a computer vision application, wherein said method comprises (i) receiving information for generating the computer vision application's output or an intermediate computation result; (ii) providing a systolic array architecture for processing the information received; and (iii) calculating convolutions in a Convolutional Neural Network (“CNN”) by implementing a Row Stationary dataflow.

According to another embodiment of this aspect of the disclosure, the systolic array architecture provided comprises at least one macro array of processing elements, wherein each of the at least one macro array comprises a plurality of basic arrays of processing elements and wherein each of the plurality of basic arrays comprises a plurality of processing elements, each of the processing elements is a synchronous digital circuit, operated with a clock signal toggling at a pre-defined frequency, and the at least one macro array, the plurality of basic arrays and the plurality of processing elements are arranged in an layered hierarchical order.

In accordance with another embodiment, the plurality of processing elements comprising each at least one data register, at least one coefficient register, at least one control register, at least one multiplier and at least one adder, and wherein said method comprises a step of executing by the plurality of processing elements a part of the process for calculating convolutions in a CNN, depending on location of each respective processing elements within a corresponding basic array to which it belongs.

According to yet another embodiment of this aspect of the disclosure the method provided further comprises outputting by at least one of the plurality of processing elements, data belonging to more than one output channel, while reusing the same input data.

By still another embodiment of this aspect of the disclosure the method provided further comprises a step of providing the macro array with a cache memory for storing features' related data and coefficients' related data thereat.

### BRIEF DESCRIPTION OF THE DRAWINGS

For a more complete understanding of the present invention, reference is now made to the following detailed description taken in conjunction with the accompanying drawing wherein:

FIG. 1 illustrates an example of a prior art Vector Dot Product Pool architecture;

FIG. 2 illustrates an example of a prior art Spatial Programable Array (SPPA) architecture;

FIG. 3. exemplifies in a schematic way, a user device for carrying out a computer vision application and construed in accordance with an embodiment of the present invention;

FIG. 4 demonstrates an example of using a Row Stationary (RS) dataflow to calculate a 2D convolution with a kernel=3 and a stride=1;

FIG. 5 demonstrates an example of using a Row Stationary (RS) dataflow to calculate a 2D convolution with a kernel=3 and a stride=2;

FIG. 6 illustrates an example of a high-level structure of a PE construed in accordance with an embodiment of the present invention;

FIG. 7 demonstrates an example of a timing diagram of a PE construed in accordance with an embodiment of the present invention;

FIG. 8 illustrates an example of data registers of a PE construed in accordance with an embodiment of the present invention;

FIG. 9 illustrates an example of coefficient registers of a PE construed in accordance with an embodiment of the present invention;

FIG. 10 demonstrates an example of a basic array of PEs construed in accordance with an embodiment of the present invention;

FIG. 11 exemplifies dataflow delays that occur in a PEs' array construed in accordance with an embodiment of the present invention;

FIG. 12 exemplifies inter-PE feature connectivity for a kernel=3 and stride=1 using the PE of FIG. 6;

FIG. 13 exemplifies inter-PE feature connectivity for a kernel=3 and stride=2 using the PE of FIG. 6;

FIG. 14 exemplifies inter-PE feature connectivity for a kernel=4 and stride=1 using the PE of FIG. 6;

FIG. 15 exemplifies inter-PE feature connectivity for a kernel=4 and stride=2 using the PE of FIG. 6;

FIG. 16 demonstrates an example of a macro array comprising a plurality of basic arrays and construed in accordance with an embodiment of the present invention;

FIG. 17 demonstrates an example of an FFU group comprising V+V/1.2×(H−1) FFUs (where in this example, V=12 and H=4), arranged to support the configurations illustrated in FIG. 10;

FIG. 18 illustrates an example of an FFU construed in accordance with an embodiment of the present invention;

FIG. 19 demonstrates an example of a CFU group construed in accordance with an embodiment of the present invention;

FIG. 20 illustrates an example of a high-level architecture of PPU, construed in accordance with an embodiment of the present invention;

FIG. 21 demonstrates an example of an aggregate processing task in accordance with an embodiment of the present invention;

FIG. 22 demonstrates an example of a parallel processing task in accordance with an embodiment of the present invention;

FIG. 23 demonstrates an example of an independent processing task in accordance with an embodiment of the present invention;

FIG. 24 demonstrates an example of a method to carry out calculation for kernel=5 convolutions in accordance with an embodiment of the present invention;

FIG. 25 demonstrates an example of a method to carry out a kernel=5 convolution for group ‘a’ output features, using kernel=3 convolutions, in accordance with an embodiment of the present invention;

FIG. 26 demonstrates an example of a method to carry out a kernel=5 convolution for group ‘b’ output features, using kernel=3, in accordance with an embodiment of the present invention;

FIG. 27 demonstrates an example of a method to carry out a calculation for kernel=7 convolution in accordance with an embodiment of the present invention;

FIG. 28 demonstrates an example of a method to carry out a calculation for kernel=7 convolution as depicted in FIG. 27, wherein the calculation of group ‘a’ output features is illustrated in this FIG. in accordance with an embodiment of the present invention;

FIG. 29 demonstrates an example of a method to carry out a Convolution with kernel=3 with Dilation=2 in accordance with an embodiment of the present invention where the concept of 4 input pixel groups and four output pixel groups is used (as shown in FIG. 29 for kernel=3).

FIG. 30 demonstrates an example of a method to carry out a Convolution with kernel=3 and Dilation=2 for output pixels in group ‘a’; and

FIG. 31 demonstrates an example for calculating convolution with kernel=3 and Dilation=3, by splitting the input and output pixels into 9 groups (‘A’ to ‘I’ and ‘a’ to ‘i’).

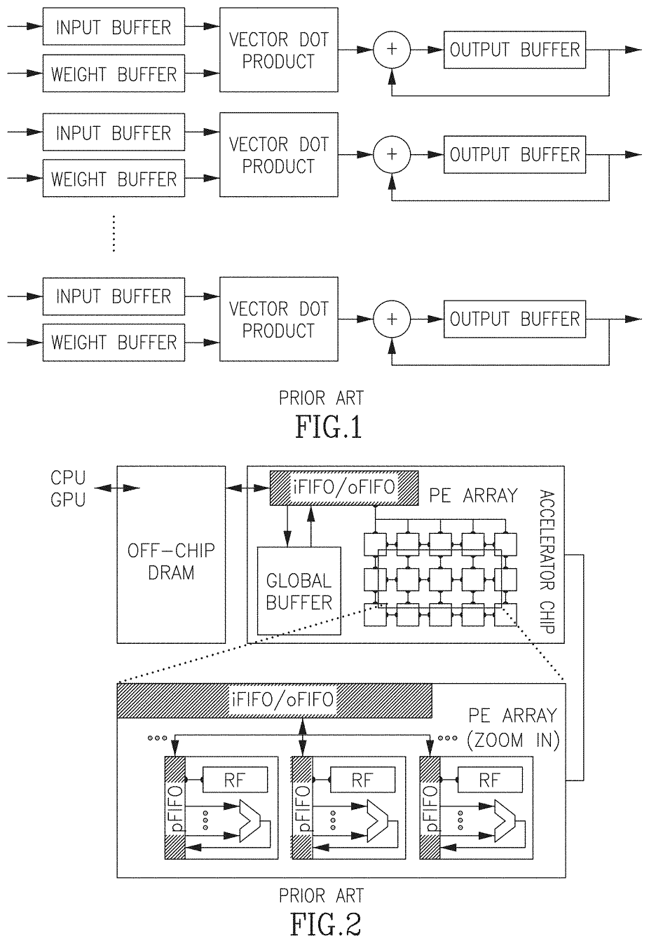

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

As discussed above, one of the major objects of the present invention is to provide novel method and apparatus that implement innovative systolic array architecture for the computation of CNN functions.

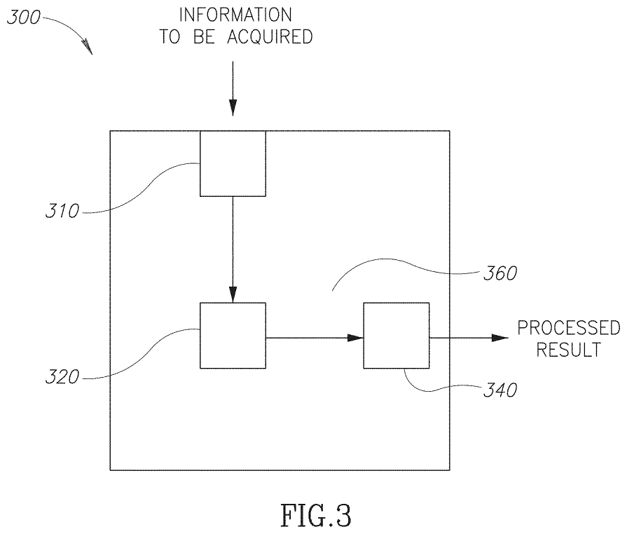

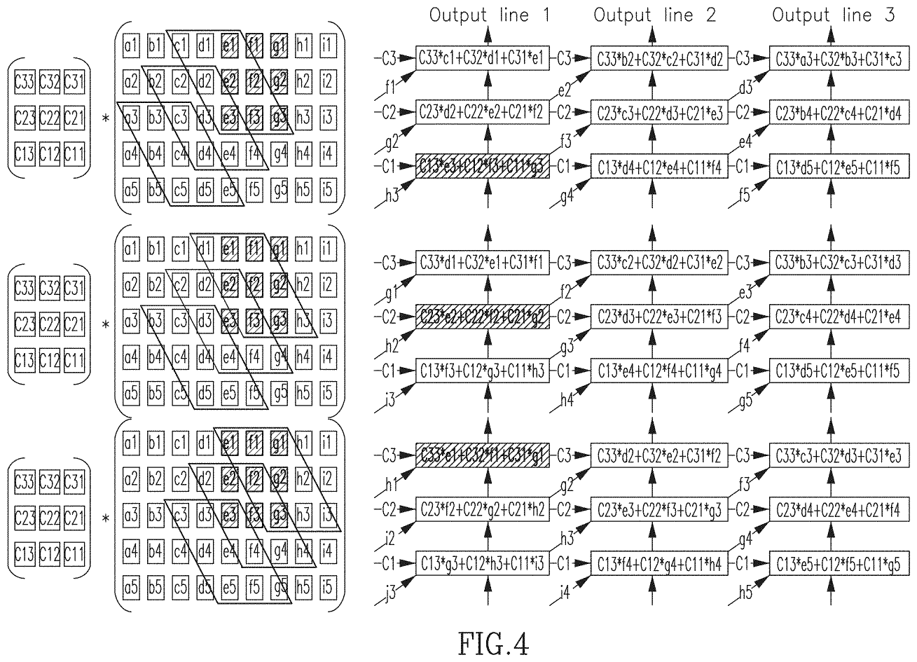

FIG. 3 exemplifies in a schematic way, a user device 300 for carrying out a computer vision application and construed in accordance with an embodiment of the present invention. In accordance with this embodiment, the user device 300 which may be for example a robotic means, AR/VR glasses, a drone or any other applicable user device, and is adapted for carrying out a computer vision application, comprises an image sensor 310 where the latter is configured to acquire and convey information for generating an image. The information is forwarded to memory 320 where it is stored and then the information is retrieved from memory 320 and processed by a processor 340 having a systolic array architecture which is configured to receive the conveyed information from memory 320 and to apply Row Stationary dataflow for calculating convolutions in a Convolutional Neural Network (“CNN”). Thus, the outcome of processing, analyzing and understanding the digital images acquired by processor 340 enable extraction of high-dimensional data from the real world and to generate numerical or symbolic information therefrom, e.g., generation of decisions.

The proposed systolic array architecture of the present invention uses Row Stationary (RS) dataflow. This fact renders the proposed architecture not as flexible as SPPA architecture (for example the one used in the Eyeris project). However, systolic architectures, including the one comprised in the present solution, are more power efficient and area efficient than SPPA architectures, as SPPA architectures sacrifice efficiency for flexibility. In addition, the systolic architecture proposed by the present invention is more scalable than the SPPA solution (i.e., it can be scaled to support much higher processing power). For example, the Eyeriss SPPA chip contains 168 PE's while the architecture proposed by the present solution can contain tens of thousands of PEs in a typical implementation.

Google's TPU is a systolic array that employs a matrix multiplication data flow. As such, it is efficient in terms of power and area per multiply-accumulate operation. However, the proposed architecture of the present invention yields better computational efficiency (i.e., the average activity factor of MAC units), and has a more regular feature and coefficient feed pattern (i.e., it is simpler and more efficient to manipulate data when fetching it from the memory or while storing it in the memory). Thus, the present proposed solution is able to provide lower power and area per “functional” MAC, than can be achieved while implementing the TPU solution.

As discussed above, the present invention relies on innovative systolic array architecture for the computation of CNN functions. Processing arrays that employ Row-Stationary (RS) dataflow are known in the art (employing SPPA architecture). However, contrary to the prior art solutions, the present solution relies on principles that allow one to implement a RS compute engine in an efficient novel way in terms of silicon area, power consumption, functional efficiency (i.e., support of different CNN functions) and computational efficiency (i.e., the ratio between the number of MAC operations per second that are actually computed, and the number of MAC computational units in the array multiplied by the clock frequency).

In order to save power, the present disclosure seeks to implement PEs that are as simple as possible. However, in order to preserve sufficient functional flexibility, the present invention proposes to allow each PE to support the following functions natively: convolution with kernel=3 or 4, stride=1 or 2, and dilation=1. In the proceeding description it will be shown how other kernel sizes and dilation values may be supported by using these basic PEs.

Let us begin by describing the architecture of the present solution that is based on processing elements that calculate results for two output channels. This means that the PE performs two independent convolutions (one after the other), using the same input features but with a different set of coefficients. Later on, the benefits of using this approach will be demonstrated and also it will be shown how to configure an architecture that relies on PEs that calculate one output channel, or more than two output channels.

### Processing Elements

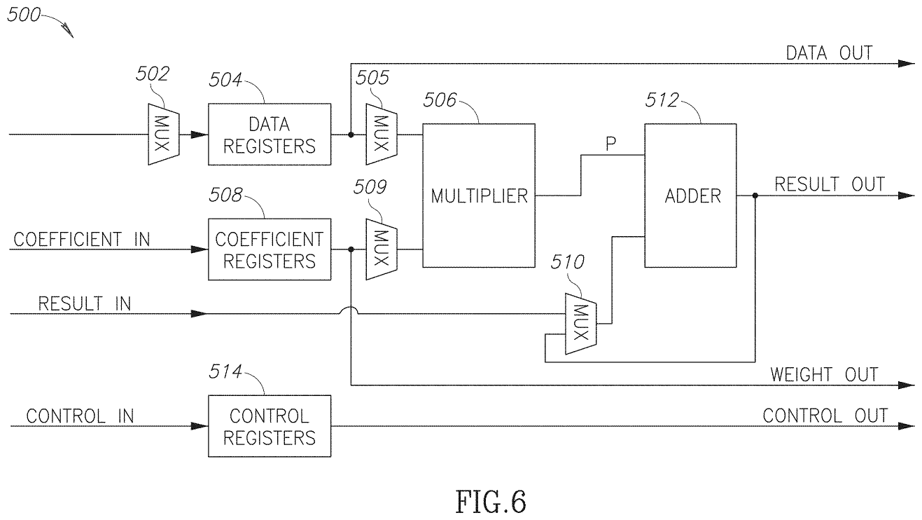

A high-level structure of a PE according to an embodiment of the present invention is illustrated in FIG. 6.

PE 500 is a synchronous digital circuit, operated with a clock signal toggling at frequency=f. The data input to the PE is forwarded via multiplexer (MUX) 502 to data registers 504 from which two flows are being forwarded. One flow exits the PE as a data out flow, whereas the second flow is forwarded via MUX 505 to multiplier 506.

The input coefficients' flow to the PE is forwarded to coefficient registers 508 from which two flows are being forwarded. One flow exits the PE as a weight out flow, whereas the second flow is forwarded via MUX 509 to multiplier 506.

In addition, a result-in flow is introduced to the PE and is forwarded to MUX 510 together with a flow of result out that leaves adder 512. The outcome of MUX 510 together with the outcome of multiplier 506 are forwarded to adder 512. The output of adder 512 is forwarded partially back to MUX 510 as described above, whereas a second flow of the outgoing results leaves the PE.

Finally, a control-in flow reaches the PE, sampled and stored at control registers 514, from which it will leave when appropriate the PE to be used by other PEs as control input.

PE 500 executes one MAC operation per clock cycle. When configured to work with k=3, PE 500 operates with macro cycles of 3 clocks, and when configured to work with k=4, PE 500 operates with macro cycles of 4 clocks.

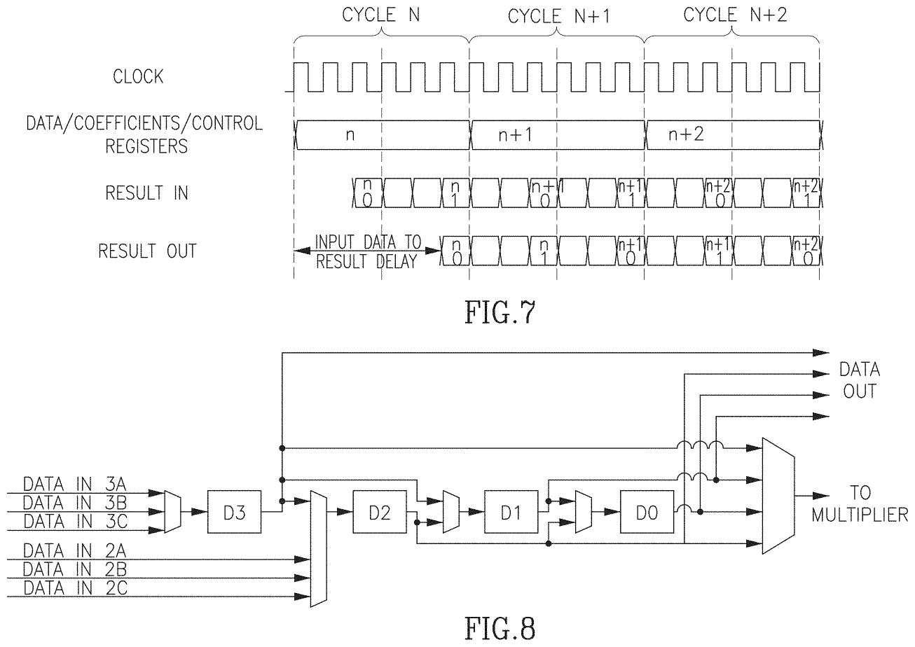

FIG. 7 illustrates a timing diagram of PE 500, when configured to work with k=3. It should be noted that time is split to feed cycles, where each feed cycle is composed of two macro cycles.

PE 500 receives and samples new control information every feed cycle (i.e., every two macro cycles), and the control specifies for the PE how it should function in the proceeding calculation cycle. The control is sampled and stored at a control register 514. The control register is routed out, to be used by other PEs as control input. If the control indicates that a calculation cycle is needed, new feature data (i.e., feature) will accompany the control and will be sampled into the data registers 504. If the control indicates that new coefficients should be loaded, new coefficients will accompany the control and will be sampled into coefficient registers 508.

The PE generates Result Out outputs after input-to-output delay from the control sampling time. First the result for channel 0 is delivered out and then, one macro cycle later, the result for channel 1 is delivered out. The PE also uses Result-In inputs for the calculation. Result-In signals are ready one macro cycle before Result-Out are pushed out (first Result-In for channel 0 is available and then Result-In for channel 1 is available). Result-Out signals are used by neighbor PEs as Result-In signals. When Result-Out from a certain PE is used as Result-In by another PE, it means that their feed cycles are shifted by one macro cycle).

Four data registers (designated as 504 in FIG. 6): D3 to D0, are illustrated in FIG. 8. The data registers are connected as shift registers. When stride=1, for every feed cycle, a single data sample is pushed in to D3, whereas the old D3 content is moved to D2, etc. During the calculation process, multiplier 506 is fed with D3 to D1 for kernel=3 and D3 to D0 for kernel=4.

When stride=2, every feed cycle, two data samples are pushed into D3 and D2, while the old D3 content is moved to D1 and old D2 content is moved into D0. During the calculation process, the multiplier is fed with D3 to D1 for kernel=3 and D3 to D0 for kernel=4.

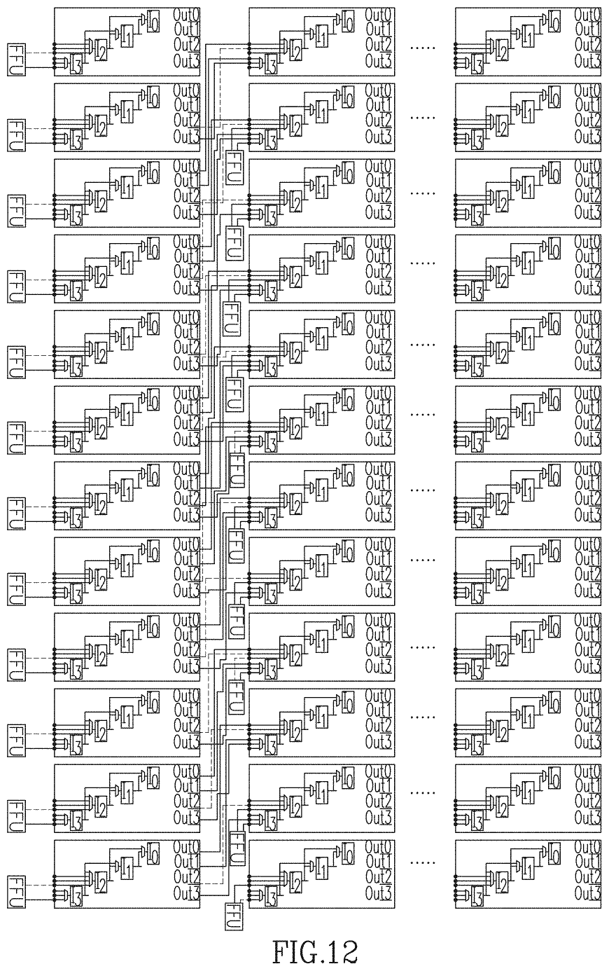

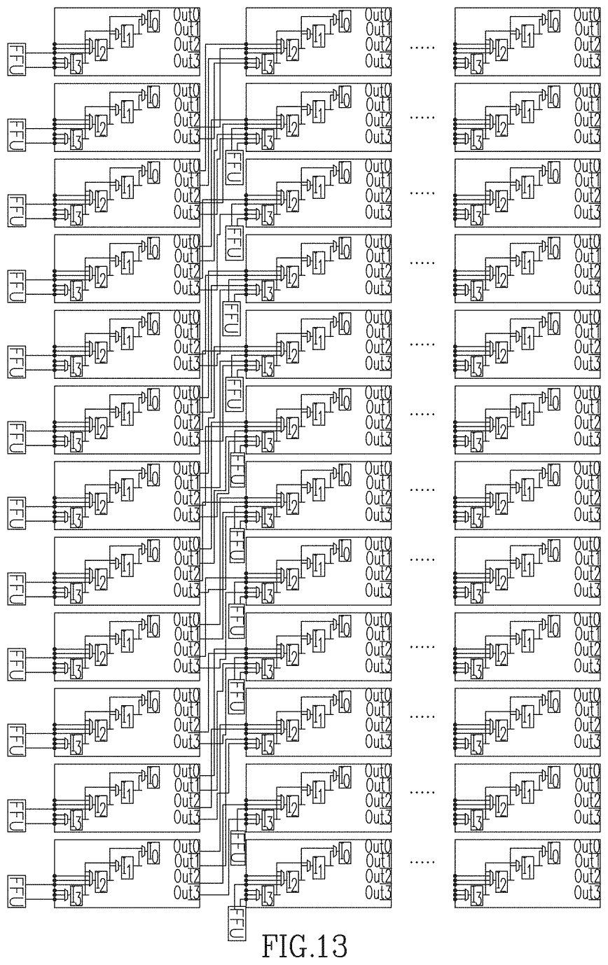

It should be noted that several external data input sources can be selected for D3 and D2. This enables supporting different kernel/stride modes that require different inter-PE data connectivity (as illustrated in FIGS. 12 to 15 that will be discussed later on).

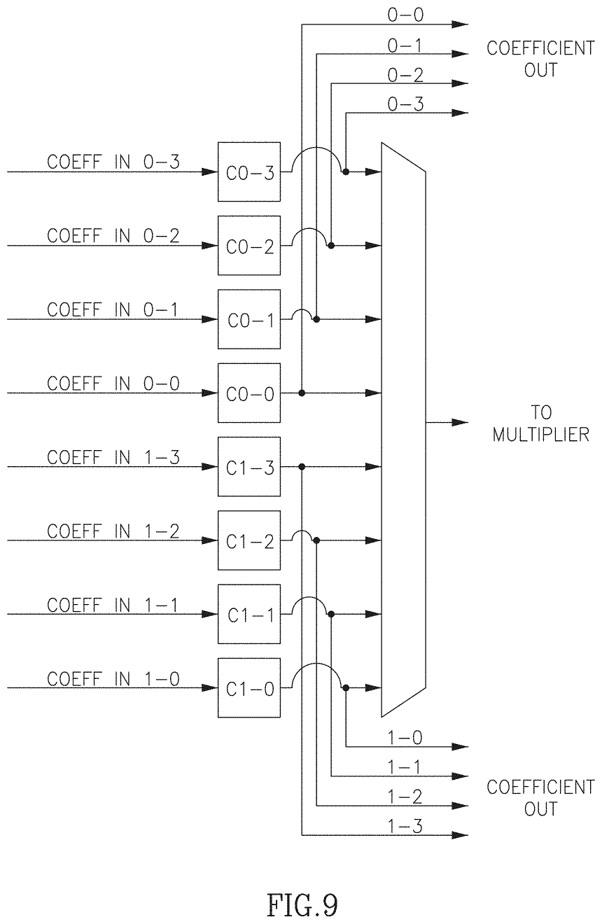

FIG. 9 illustrates the PE coefficient registers (designated as 508 in FIG. 6). There are two sets of coefficient registers: one set comprises registers C₀₋₃ to C₀₋₀ (associated with output channel 0) and the other set of registers C₁₋₃ to C₁₋₀ (relating to output channel 1). The coefficients are loaded to the coefficient registers in parallel at the beginning of the feed cycle, if needed (i.e., if the control word specifies that a change should be affected in the coefficients values).

The multiplier block 506 and adder block 512 in PE 500, calculate the convolution function:

$${Result}_{Out} = {Result}_{In} + {\sum }_{i = 1}^{k - 1} {C}_{i} \cdot {D}_{i}$$

The multiplier and adder in the PE have each at least one pipeline delay (i.e., their respective outputs are delayed by at least one clock cycle with respect to their input). The multiplexers 505 and 509 can also have a pipeline delay if needed. The number of pipeline delays is a dominant factor in the input-to-output delay of the PE.

The following table (Table 1) illustrates an example for the PE operation when kernel=3. Every column in the table represents one clock cycle. In this table, Result-In is designated as Sᵢₙ, Result-Out as Sₒᵤₜ and the multiplier's output as P. The PE's calculation results are shown in bold (the first bold result refers to channel 0 whereas the second to channel 1). In this example the multiplier (including the multiplexer 505 and 509) has a pipeline delay of three clock cycles, and the adder has a pipeline delay of one clock cycle. The input-to-output delay is 6 clock cycles.

TABLE 1

| | | |
|---|---|---|
| Data, Control, | New | New |
| Coeff. registers | value | value |

| | | | | | | | | | |
|---|---|---|---|---|---|---|---|---|---|
| Multiplier (P) | D₃C₀₋₃ | D₂C₀₋₂ | D₁C₀₋₁ | D₃C₁₋₃ | D₂C₁₋₂ | D₁C₁₋₁ | D₃C₀₋₃ | D₂C₀₋₂ | D₁C₀₋₁ |
| Adder (Sₒᵤₜ) | | P + Sᵢₙ | P + S | P + S | P + Sᵢₙ | P + S | P + S | P + Sᵢₙ | P + S |

The following table (Table 2) illustrates another example for a PE operation, this time with a kernel=4 (with pipeline delays that identical to the delays of the previous example).

TABLE 2

| | | |
|---|---|---|
| Data, Control, | New | New |
| Coeff. registers | value | value |

| | | | | | | | | | |
|---|---|---|---|---|---|---|---|---|---|
| Multiplier (P) | D₃C₀₋₃ | D₂C₀₋₂ | D₁C₀₋₁ | D₀C₀₋₀ | D₃C₁₋₃ | D₂C₁₋₂ | D₁C₁₋₁ | D₀C₁₋₀ | D₃C₀₋₃ |
| Adder (Sₒᵤₜ) | | P + Sᵢₙ | P + S | P + S | P + S | P + Sᵢₙ | P + S | P + S | P + S |

### Basic Array

Processing. Elements (PEs) are grouped into Basic Arrays (BA). Each BA is composed of V rows and H columns of processing elements. Preferably but not necessarily, V is dividable by 3 and 4. This allows the BA to be configured to operate in both modes of kernel=3 or kernel=4.

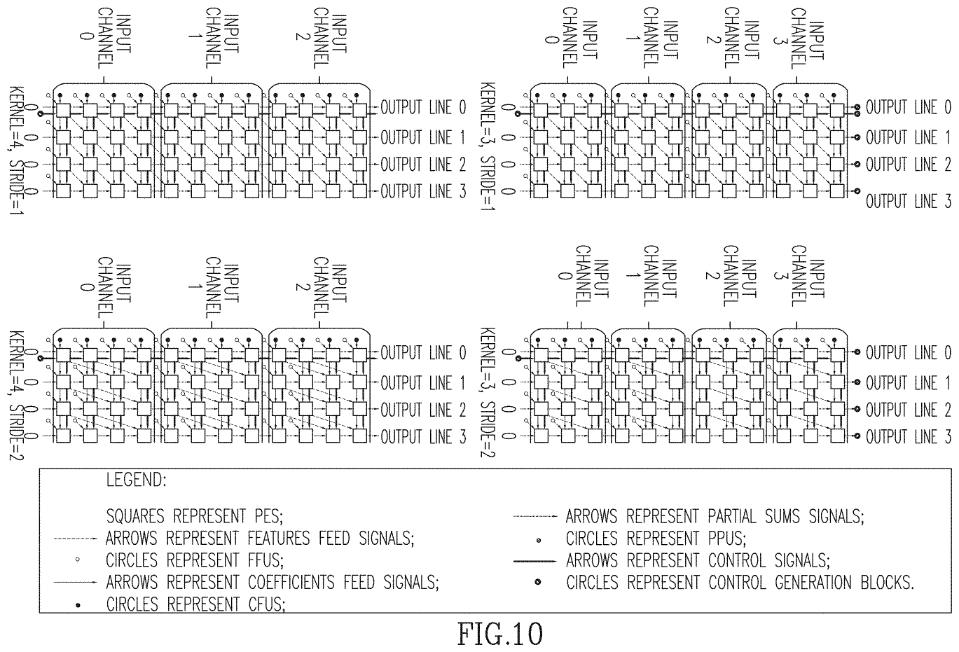

FIG. 10 illustrates an example for a BA having twelve rows (V=12) and four columns (H=4). When kernel=3, there are four input channels that feed the array. When kernel=4, there are three input channels that feed the array.

FIG. 10 depicts the processing elements, features' feed signals and Feature Feed Units (FFU), that are used to push features into the systolic array. It should be noted however that the feature feed connectivity depends on the mode of operation.

Furthermore, the Fig. depicts coefficients feed signals and Coefficient Feed Units (CFU).

Next, the Fig. illustrates partial sums signals and Post Processing Units (PPUs). These units add the result obtained from the BA to partial results that might have been prepared during earlier calculation cycles.

Finally, control signals are illustrated in FIG. 10 as well as control generation blocks.

In this example, the underlying assumption regarding data flow in the BA is that each PE adds a delay of one macro cycle to the flows of control, coefficients and partial sum that are conveyed via that PE. So, for example, if PE-B receives its coefficient from PE-A, PE-B will start using the new coefficient set one macro cycle after PE-A.

When the execution of a new calculation task by the engine begins, it will advance like a wave via the BA, namely, starting from the left bottom PE and advancing right and up. The control signals also propagate like a wave within the array. The control input of every PE is connected to the control output of a PE below it or on its left. The PE in the bottom left corner gets its control from a control generation block.

The coefficients flow advances from left to right. The coefficient input of every PE is connected to the coefficient output of the PE on its left. The PEs on the left edge of the array are being fed with coefficients from the Coefficient Feed Units (CFUs).

The Partial Sum flow advances upwardly. The partial sum input to every PE is connected to the partial sum output of the PE located in this FIG. beneath it. The PEs on the bottom row are connected to zero.

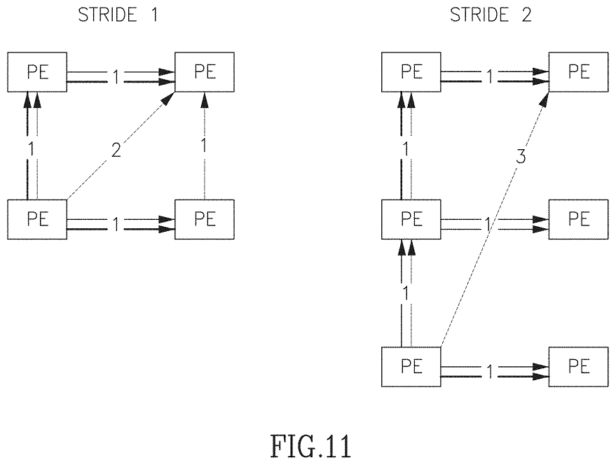

FIG. 11 illustrates the dataflow delays (in macro cycles) that occur in the PEs' array. It should be noted that features that are conveyed from one PE to another, are aligned to the calculation wave delay. So, when stride=1, if PE-A feeds features to PE-B, a certain pixel that is being fed to PE-A should arrive to PE-B two macro cycles later. For stride=2, the delay from source PE to target PE should be three macrocycles.

FIG. 12 to FIG. 15 illustrate the feature feed connectivity between PEs in a BA for different modes of operations. Each of these four cases, comprises active lines (the actual connectivity in the array is the unification of all the lines in FIGS. 12 to 15). The presented connectivity achieves the required delay pattern as presented in FIG. 11. In the stride=1 cases, there are optional connectivity for the first feed cycle in the calculation task. These lines allow to load two features in the first feed cycle to improve efficiency.

### Macro Array

A Macro Array (MA) consists of several rows and columns of Basic Arrays (BAs), supports logic around these BAs that is responsible to feed and harvest data from the processing elements, and control logic.

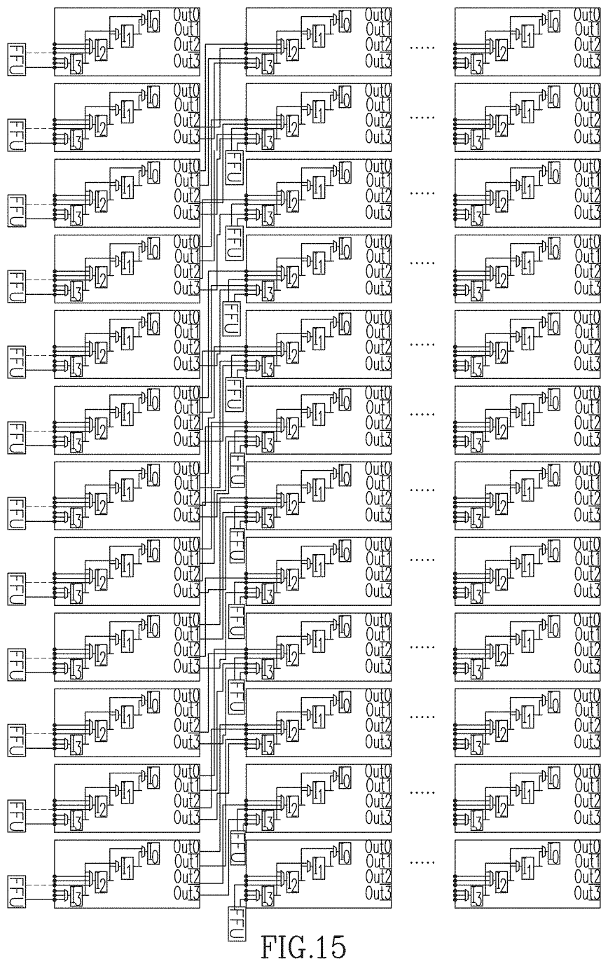

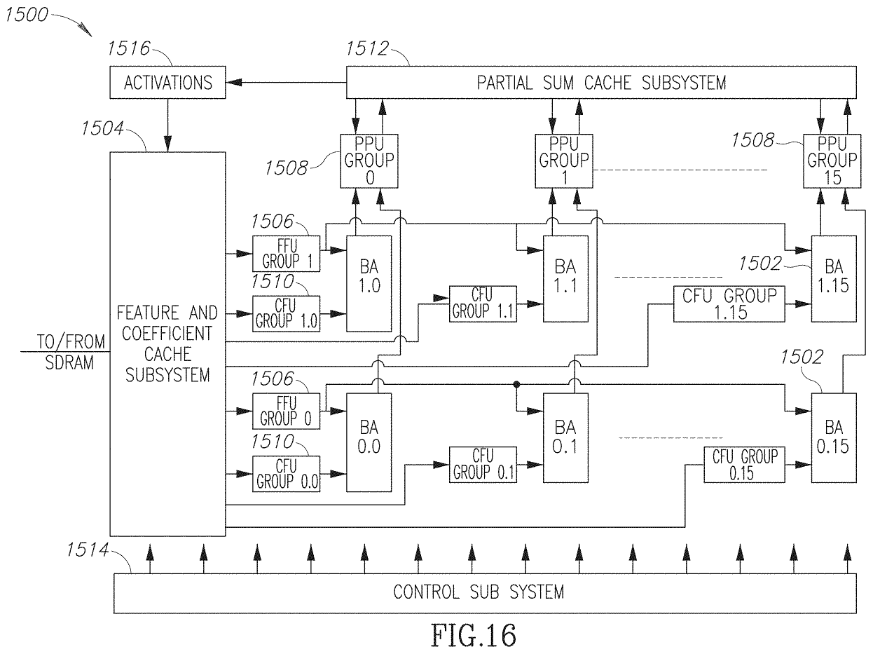

The example demonstrated in FIG. 16 depicts an MA 1500 that comprises 32 BAs (1502), arranged in an array that has two rows and 16 columns, 16 PPUs (1508), 32 CFUs (1510), each associated with a respective BA, two FFUs (1506), each associated with a BA row, a Feature and Coefficient Cache Subsystem (1504), a Partial-Sum Cache subsystem (1512), a control sub system (1514) and an activation block (1516).

Input features and coefficients are being fed to the Basic Arrays (1502) from a Feature and Coefficient Cache Subsystem 1504 (also referred to hereinbelow as FC-Cache). Output features, after going through convolution and activation function block (1516), are stored back in the FC-Cache Subsystem 1504. FC-Cache Subsystem 1504 is composed of memory blocks and cross connect routing fabric which supports fetching different combinations of features and coefficient patterns as needed for performing different CNN functions by the MA. The FC-Cache is connected to the outer world (e.g., to an SDRAM) via regular SOC bus (e.g., AXI). New input features and coefficient can be brought from the SDRAM to the FC-Cache via this path, and new output features can be sent back to the SDRAM via this path. The FC-Cache has the following purposes:
It enables to fetch any feature several times and avoid the expensive access to SDRAM
It allows very high feed bandwidth that may be required for the computation array. This can be achieved by employing a wide memory array.
It allows the accelerator to compute several layers without having to exit the MA and accessing the SDRAM. In this case output features are stored in the FC-Cache and are used as input features for the next layer.

The specific structure of the FC-Cache is not described in this example, and any suitable structure for such an FC-Cache, may be implemented by those skilled in the art without departing from the scope of the present invention.

All the BAs which are located at the same row of the MA row are connected (in parallel) to the same FFU group (1506). This configuration is helpful in improving the feature's reuse factor, as more output channels are being calculated concurrently using the same input features. If for example, the MA consists of 16 columns of BAs, and since each BA calculates two output channels, each row in the MA calculates 32 output channels concurrently.

Each FFU group (1506) contains V+V/1.2×(H−1) FFUs, arranged in a way that can support all configurations as illustrated in FIG. 10. For example, if the BA has 12 rows and 4 columns of PEs, there are 42 FFUs in an FFU group as illustrated in FIG. 17.

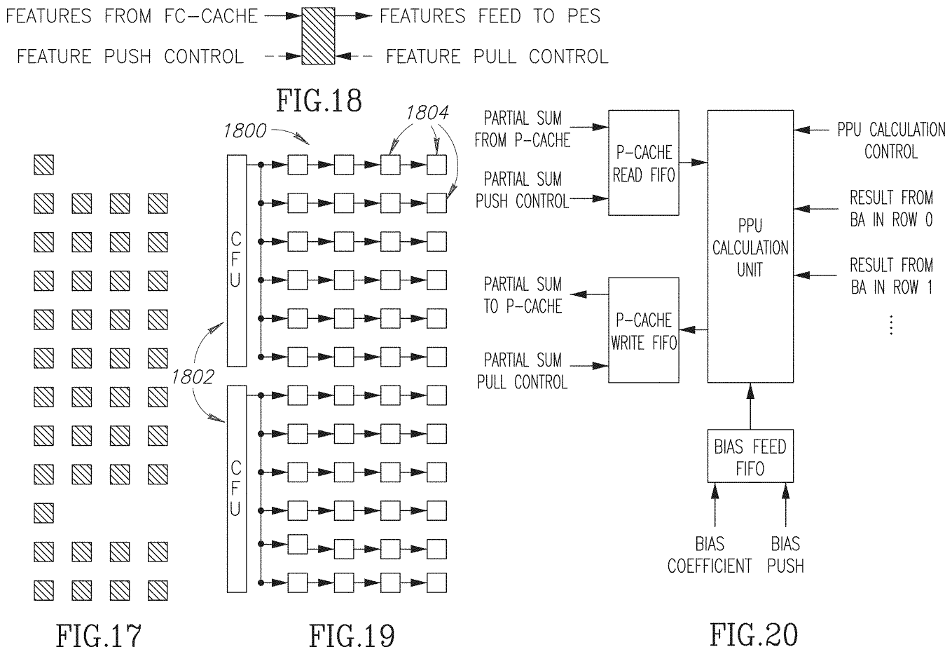

An example of an FFU is illustrated in FIG. 18. As may be seen from this FIG., each FFU is mainly a FIFO with some support logic. Features coming from the FC-Cache subsystem are pushed to the FIFO and, when needed, they are pulled out and feed the relevant PEs. The FFU can also add padding or zero features as needed for the convolution function. Push control signals accompany the features that are introduced into the FFU, and Pull Control signals indicate when it is time to pull out these features. The pull control signals also indicate the exact pull function that should be performed (e.g., pulling one feature per feed cycle for stride 1 or two features per feed cycle for stride 2, etc.). The timing of the pull control signals should preferably be perfectly synchronized with the processing timing of the PEs. In some cases, two features may be needed for a single feed cycle. However, since each feed cycle is twice longer than a macro cycle, the FIFO can be 1 feature wide, and still operate at macrocycle timing grid at the output. In the example illustrated in FIG. 16, each FFU is connected in parallel to several PE's, located at different BAs.

Each BA in the MA is connected to a different CFU group (as illustrated in FIG. 16). It is not required to load coefficients to a certain PE every feed cycle. In addition, coefficients are loaded to PEs in a wave-like type of operation. Thus, one can connect one CFU to several PEs in parallel. The example illustrated in FIG. 19, illustrates a CFU group 1800 that comprises two CFUs (1802), and feeds coefficients to a BA with 12×4 PEs (1804). In this example, each CFU feeds six PE's and the minimum coefficient feed period will be six macro cycles. In other words, it is not possible to replace a coefficient with another, in a certain PE, until at least 6 macro cycles have passed.

Each CFU comprises a FIFO with some support logic. Coefficients coming from the FC-Cache subsystem are pushed to the FIFO and, when needed, they are pulled out and feed the PEs. Push control signals accompany the respective coefficients that are introduced to the CFU and Pull Control signals indicate when it is time to pull out the coefficients. The timing of the pull control signals should preferably be perfectly synchronized with the processing timing of the PEs.

FIG. 20 illustrates a high-level architecture of a Post Processing Unit (PPU).

The calculation results are forwarded from BAs to Post Processing Units. The target of the PPUs is to aggregate results coming from multiple calculation tasks and/or different BAs, and add bias. In operation, results coming out from the same BA but at different calculation cycles may be aggregated, as well as results that come from different BAs during the same calculation cycles which may be aggregated too, or any combination of these two types of results' aggregations. The PPUs operate closely with a Partial Sum cache memory (designated as P-Cache in FIG. 20) where previous partial sums are stored. The functional flow within the PPU may be described as follows:
1. Read the partial sum from the P-Cache;
2. Add the result coming from one or more BAs; and
3. Write the summary result back to the partial sum cache.

If there is no earlier partial sum in the P-Cache, the PPU adds the bias value instead.

In addition to the calculation unit discussed above, each PPU comprises a FIFO for partial sums coming into the PPU, a FIFO for the partial sums going out of the PPU and a FIFO for the bias coefficients. The use of FIFOs helps to detach between the time of loading (or storing) the data from memories and the time data used. In other words, the relevant data can be brought or sent asynchronously for the actual time calculation. The bias coefficients can be brought from the FC-cache or from another data source. Here too, the timing of the calculation control signals should preferably be perfectly synchronized with the processing timing of the PEs.

Each PPU group comprises at least H PPUs (one PPU associated with each PE column of a BA). It is possible to multiply the number of PPUs per group by the number of BA rows per MA. In this case, BAs in different rows can operate independently. For example, if one has a 2×16 BAs in the MA (as depicted in FIG. 16), and each BA has 4 columns, then each PPU group will have 4×2 PPUs. In this case a BA at the bottom row may calculate results for output channels 0-31 while the BA at the top row may calculate results for output channels 32-63.

After a convolution result is ready in the Partial Sum Cache, it is conveyed via an Activation unit back to the FC-Cache.

On top of the described-above, the MA comprises a control unit. The control unit is responsible to generate control signals to all components included in the architecture described, such that data flow and computations are synchronized.

### Processing Tasks

A Processing Task is a processing procedure carried out by the MA of a data chunk, using a certain set of coefficients, which are not changed throughout the task. Calculation of a convolutional layer may take more than one Processing Task. In the following description, several modes of Processing Tasks are discussed.

### Aggregate Processing Task

In this example, the results obtained from two (or more) BA rows are aggregated in the PPUs. If for example, each BA has 12 rows and 4 columns of PEs, and the MA comprises 2 rows and 16 columns of BAs, then:
A maximum of 32 output channels are calculated concurrently (two output planes per BA column);
For kernel=3, a maximum of 8 input channels are processed (4 per BA row), whereas for kernel=4, a maximum of 6 input channels are processed (3 per BA row); and
Four output lines are calculated per channel (one per PE column in a BA).

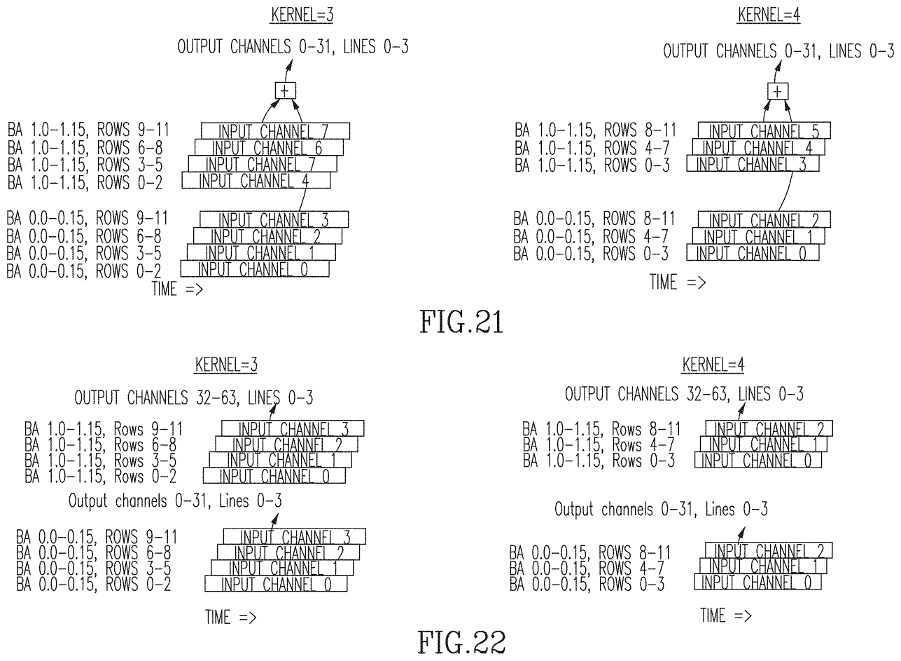

FIG. 21 demonstrates an example of an Aggregate Processing Task. In this FIG. it is demonstrated how different data are introduced into different BA rows in time. If, for example, one would decide to perform kernel=3 convolution with 64 input channels, 64 output channels, and 8 output lines, it would need to use 8 aggregated Processing Tasks (two for output channels 0-31 and lines 0-3, two for output channels 0-31 and lines 4-7, etc.).

### Parallel Processing Task

In this mode of operation, different BA rows operate in parallel on the same inputs, generating different outputs.

FIG. 22 illustrates an example of a Parallel Processing Task. In this example, each BA has 12 rows and 4 columns of PEs, and the MA consists of 2 rows and 16 columns of BAs.

### Independent Processing Task

When implementing this mode of operation, different BA rows operate on different inputs and generate different outputs. This can be used for processing different output lines with the same input channels and output channels, or processing different input channels and output channels.

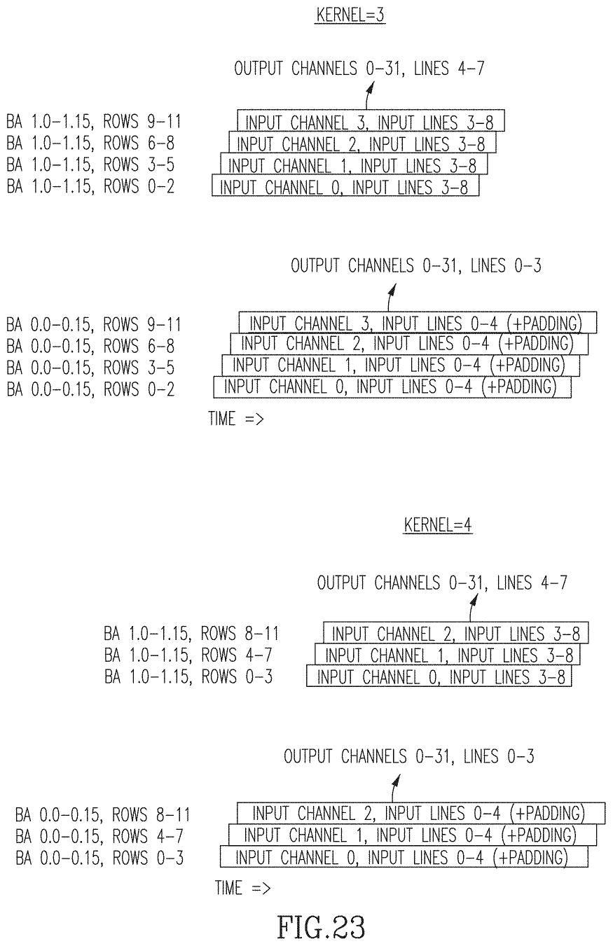

FIG. 23 illustrates an example of such an Independent Processing Task. In this example, each BA has 12 rows and 4 columns of PEs, and the MA comprises 2 rows and 16 columns of BAs. In this example, each BA row calculates different output lines of the same output channels.

### Support for Non-Native Convolution Layer

The convolution systolic array of the present disclosure supports inherently convolutions with kernels of 3 and 4 and strides of 1 and 2, and dilation of 1. The following description explains how other convolution functions can be supported.

### Kernel=5 Convolution

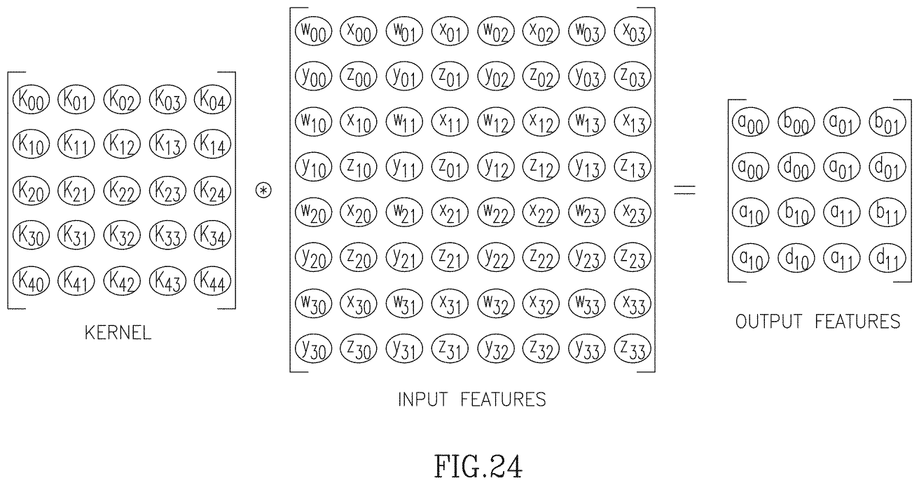

One may calculate kernel=5 convolution (with stride=1 and dilation=1) by using kernel=3 convolvers, where a convolver is an algorithm that performs convolution on a signal. The input feature maps are split into 4 groups (w, x, y, z) and the output feature maps into 4 groups (a, b, c, d), as illustrated in FIG. 24. In that FIG. the kernel matrix is represented with coefficients K₀₀ to K₄₄.

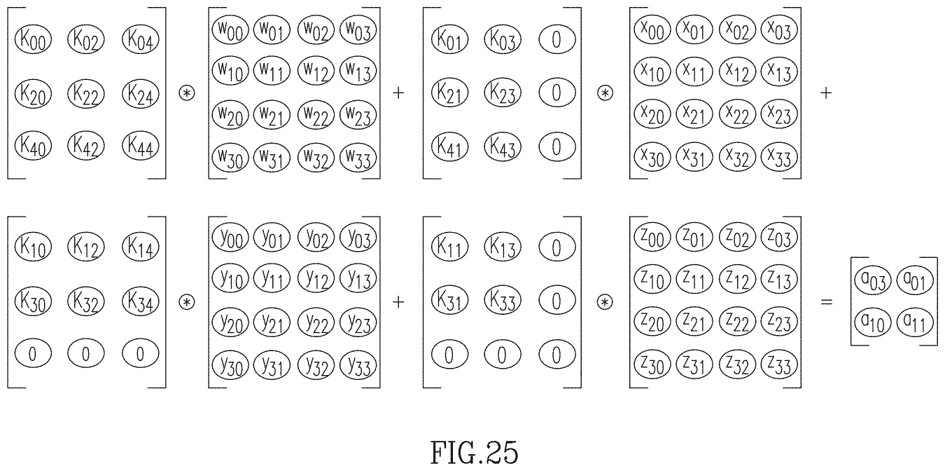

First, one of the groups' output features are calculated (for example features from group ‘a’). This is preferably carried out by summing the results of four kernel=3 convolutions as illustrated in FIG. 25, each with pixels from a different input group. The convolvers' coefficients are also illustrated in FIG. 25.

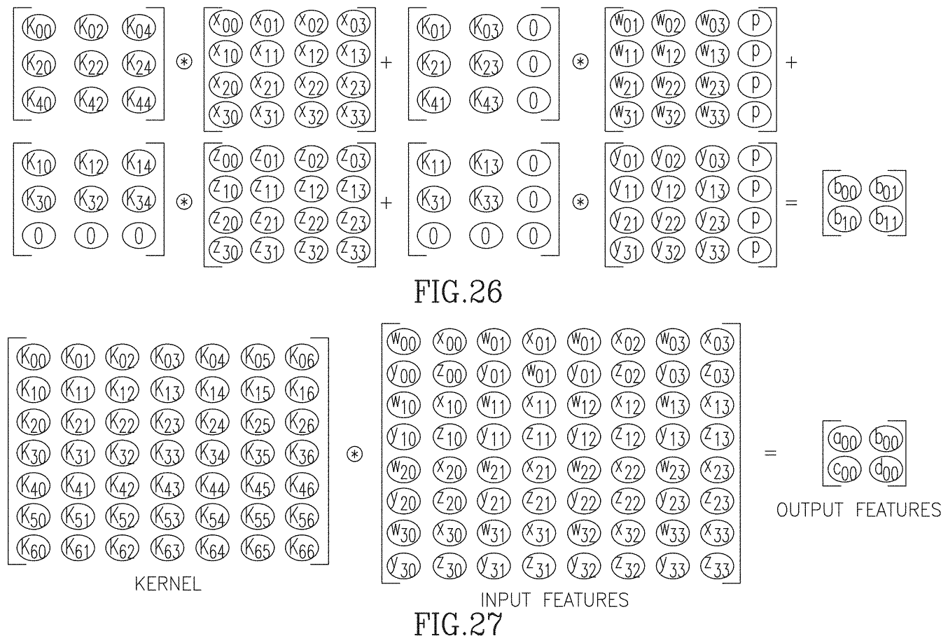

Once the calculation of the first group's output pixels is concluded, next, the second output pixels' group (e.g., group ‘b’) is calculated in a similar way (as illustrated in the following FIG. 26), then, the third group's output pixels (group ‘c’) is calculated in a similar way and finally the fourth group's output pixels (group ‘d’).

Stride 2 convolution can be calculated in a similar way to the calculation demonstrated for stride 1. However, in this case only the pixels of group ‘a’ are calculated.

### Kernel=7 Convolution

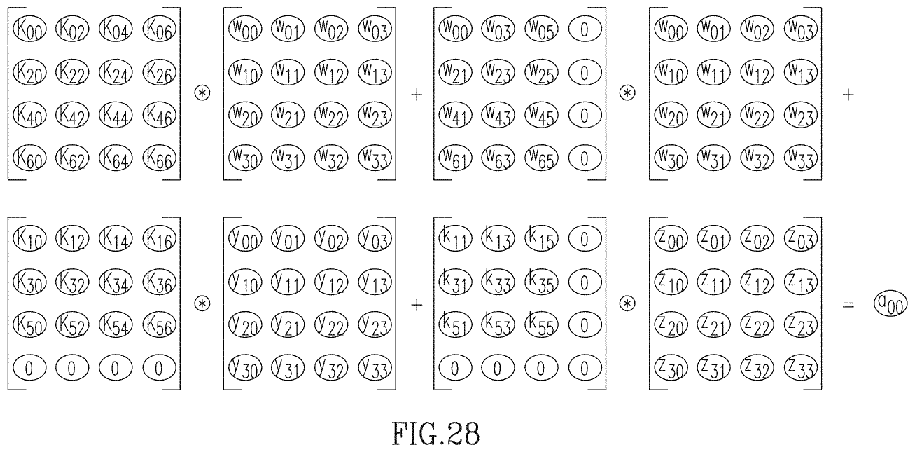

For a kernel=7 convolution a similar concept may be used as the one described for the kernel=5 case. However, in this case 4×4 convolvers are used. This type of operation is illustrated in the following FIGS. 27 and 28, where FIG. 28 illustrates how to calculate group ‘a’ pixels.

Convolution with Dilation=2

Dilated Convolutions are a type of convolution that “inflate” the kernel by inserting holes between the kernel elements. An additional parameter (dilation rate) indicates the extent by which the kernel is widened. Usually there are spaces inserted between kernel elements.

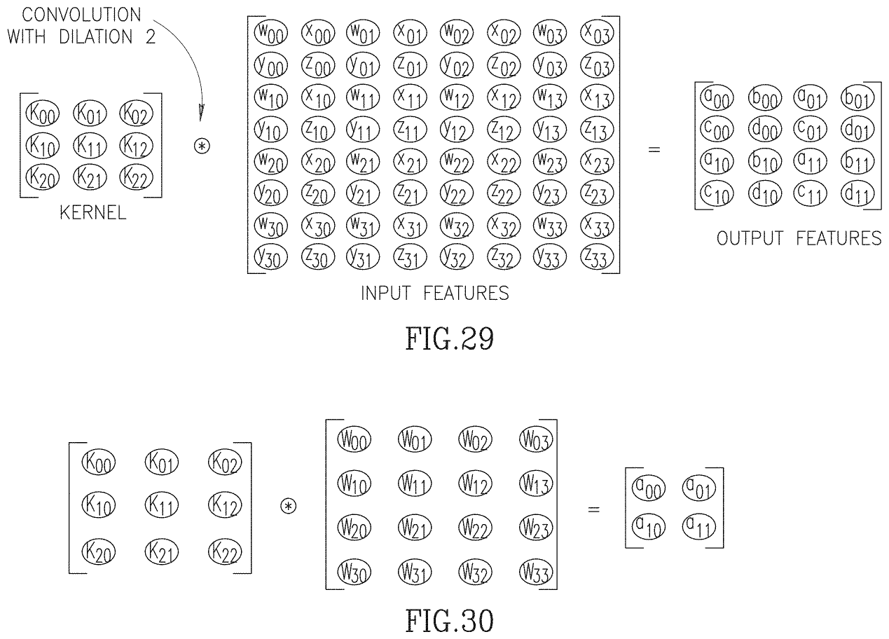

In the case of Convolution with Dilation=2, again, the concept of 4 input pixel groups and four output pixel groups is used (as shown in FIG. 29 for kernel=3).

For a kernel=3 convolution with Dilation=2 (FIG. 30) the following is carried out: for calculating the first group's output pixels (i.e., ‘a’), kernel=3 convolver is used with the first group's input pixels (i.e. group ‘w’), as seen in the following figure. For calculating the second group's output pixels, kernel=3 convolver is used with the second group input pixels, and so forth.

For a kernel=4 convolution with Dilation=2 the following is carried out: for calculating the first group's output pixels, kernel=4 convolver is used with the first group input pixels. For calculating the second group's output pixels, kernel=4 convolver is used with the second group's input pixels, and the like.

Convolution with Dilation=3

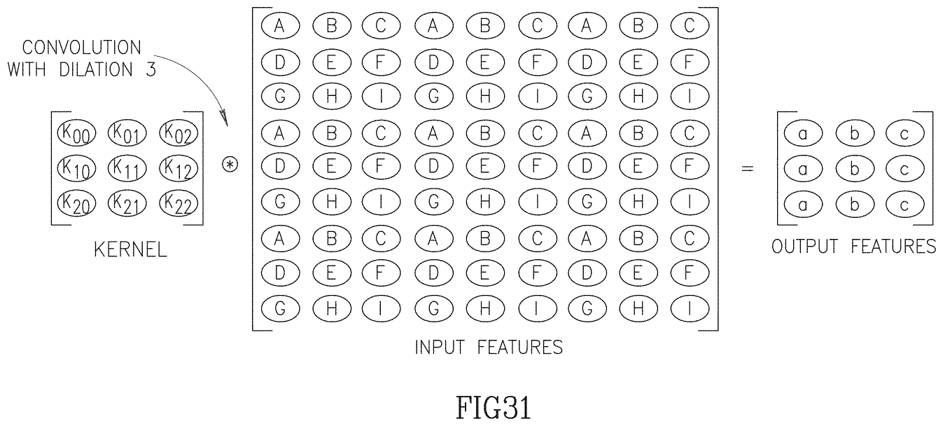

In this case the input and output pixels are split into 9 groups (‘A’ to ‘I’ and ‘a’ to ‘i’) as illustrated in FIG. 31, and each group is calculated separately (i.e., outputs ‘a’ are calculated with inputs ‘A’, outputs ‘b’ with inputs ‘B’, etc.)

### Changing the Number of Output Channels in a PE

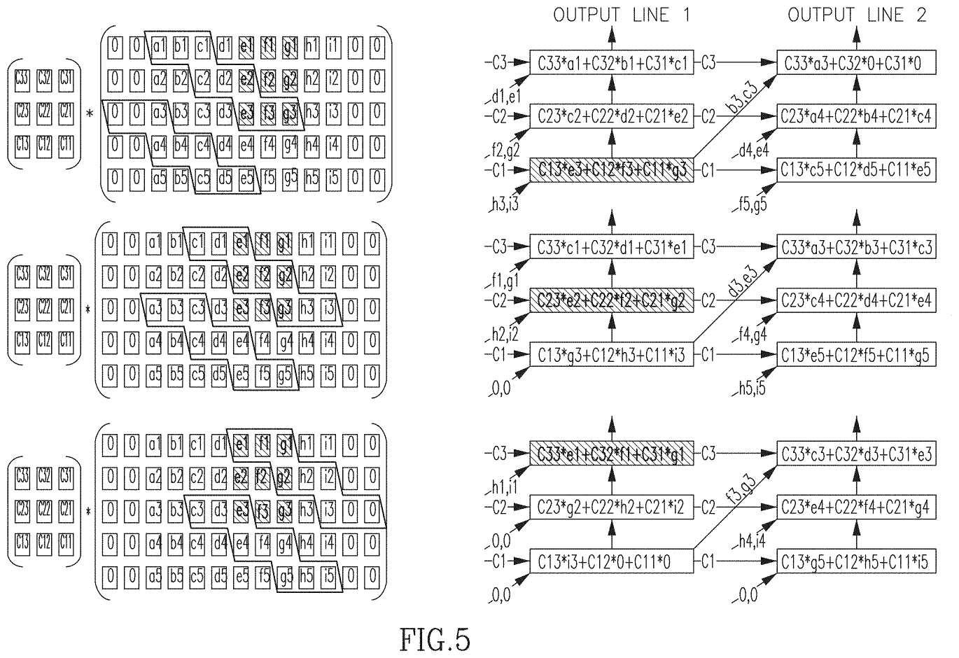

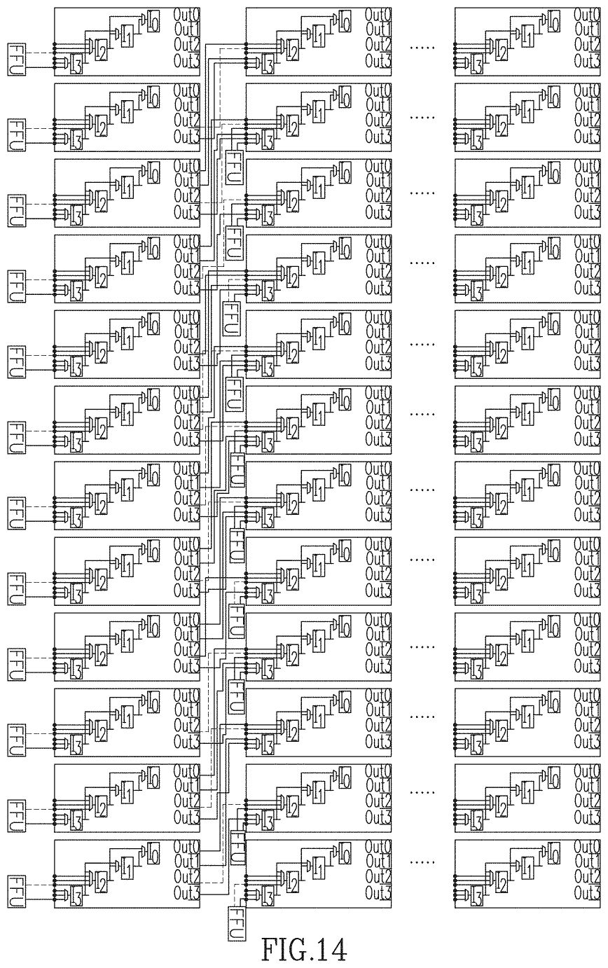

In the preceding description, the architecture referred to was based on PEs that support two output channels. It should be noted that one can implement a similar architecture by using a single output channel per PE. However, in this case the following differences will apply:
Each feed cycle should be composed of a single macro cycle;
The PE will include a single set of coefficients (and not two sets);
The PE will include 6 data registers (Instead of 4) for supporting the stride=2 case, where each PE has to “remember history” of 6 steps as can be seen in FIG. 5. The six data registers are designated as D₃, D₂, D₁, D₀, D₋₁, D₋₂. When stride=2, D₋₁ and D₋₂ are used for feeding the neighbor PE (and not D₁, and D₀ as illustrated in FIGS. 12 and 14).

One may also implement a similar architecture with more than two output channels per PE. However, in this case the following differences will apply:
Each feed cycle should be longer than two macro cycles (to be compatible with the number of output channels);
The PE will include more than two sets of coefficients (again, according to the number of output channels).

The following summarizes some of the main advantages of the present disclosure:
Systolic Array architecture is used to implement Row Stationary dataflow for calculation of convolutions in CNN.
The present solution offers a native support for convolutions with kernel 3 and 4 and stride 1 and 2 and dilation 1. This support is manifested at all levels and components which are part of the present solution. The PEs provided support for all of the above modes, the BAs while arranging that the number of PE rows is dividable by 3 and 4 and by implementing the proper inter PE connectivity options, and in other components of the solution (including FFU, CFU, and the like).
Functions, other than convolutions with kernel 3 and 4 and stride 1 and 2 and dilation 1, are supported by the proposed solution (and actually with every platform that supports convolutions with kernel 3 and 4 and stride 1 and 2). Specifically, calculating convolutions with kernel 5 or 7, and convolutions with dilations 2 or 3.
The present solution supports more than one output channel per PE which in turn allows increasing the feature reuse factor and also reducing the number of data registers per PE (from 6 to 4).
The present architecture by which the components comprised in a PE and the way they are connected to each other, as well as the operation flow which supports the RS data flow in an efficient way.
The present BA architecture and specifically the control and data connectivity between PEs in the BA, such that enables achieving a systolic operation.
The architecture of the MA including:
   The use of multiple columns in BAs (all connected to the same feature feed units), a fact that increases the feature reuse factor,
   The use of multiple rows in BAs increases the partial sum reuse factor (when using Aggregate processing tasks),
   The buffering hierarchy for features and coefficients that includes a large cache subsystem (FC cache) and features/coefficient feed units which are composed in FIFO buffers.
   The connection of multiple edge PEs in a BA to the same CFU, thereby, saving logic and power,
   The functionality of PPUs and the use of partial sum cache which complements the PE/BA functionality for achieving the required convolution functionality and provides functional flexibility by supporting Aggregate, Parallel and Independent processing tasks, and ultimately improves computation efficiency.
   The routing back of ready features from the P-cache to the FC-cache, via activation units, complemented by adding an activation function and enables the use of results from a certain layer as inputs to proceeding layers without having the approach the SDRAM for the retrieval of data.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A computational module adapted to be used in carrying out a computer vision application and comprising at least one processing means, wherein said computational module is characterized in that it has a systolic array architecture and is configured to receive information conveyed from at least one image sensor and to apply Row Stationary dataflow for calculating convolutions in a Convolutional Neural Network (“CNN”).

2. The computational module of claim 1, comprising at least one macro array of processing elements, wherein each of said at least one macro array comprises a plurality of basic arrays of processing elements and wherein each of said plurality of basic arrays comprises a plurality of processing elements, each of said processing elements is a synchronous digital circuit, operated with a clock signal toggling at a pre-defined frequency, and said at least one macro array, said plurality of basic arrays and said plurality of processing elements are arranged in an layered hierarchical order.

3. The computational module of claim 2, wherein said plurality of processing elements comprising each at least one data register, at least one coefficient register, at least one control register, at least one multiplier and at least one adder, and wherein each of said plurality of processing elements is configured to execute a part of the process for calculating convolutions in a CNN, depending on location of each respective processing elements within a corresponding basic array to which it belongs.

4. The computational module of claim 2, wherein the native calculated convolutions in said module comprise convolutions having a kernel=3 or a kernel=4, together with a stride=1 or a stride=2 and together with dilation=1.

5. The computational module of claim 4, wherein the native convolutions having a kernel=3 or a kernel=4, together with a stride=1 or a stride=2, and together with dilation=1, are used to calculate convolutions with a kernel that is equal to 3, 4, 5, or 7, together with a stride that is equal to 1 or 2, and together with a dilation that is equal to 1, 2 or 3.

6. The computational module of claim 2, wherein at least one of said plurality of processing elements is adapted to output data belonging to more than one output channel, while reusing the same input data.

7. The computational module of claim 2, wherein said macro array is arranged in a plurality of rows and columns, each row comprises a plurality of basic arrays, and wherein all basic arrays included in a respective row of said macro array are fed with the same input feature stream via a single feature feed unit group, configured to forward features' related data for calculating CNN convolutions using the systolic array architecture.

8. The computational module of claim 2, wherein said macro array is provided with a cache memory for storing features' related data and coefficients' related data thereat.

9. The computational module of claim 2, wherein all processing elements located along an edge of a respective basic array are connected to a single coefficient feed unit group, configured to forward coefficients' related data for all processing elements associated with said respective basic array.

10. The computational module of claim 2, wherein said processing elements included in each of said plurality of basic arrays are arranged in a way that ensures a systolic operation of said user device.

11. The computational module of claim 10, wherein said processing elements are arranged in each of said plurality of basic arrays in a way that ensures connectivity between said processing elements that enables conveyance of data and control information in order to achieve the systolic operation of said user device.

12. The computational module of claim 8, wherein results obtain from one neural network layer are stored back in the cache memory and used as inputs for one or more downstream layers without having to approach an external memory to retrieve required data therefrom.

13. A method for carrying out a computer vision application, wherein said method comprises (i) providing a computational module having a systolic array architecture for processing data required for generating an image; (ii) receiving data conveyed from an image sensor; and (iii) calculating convolutions by a Convolutional Neural Network (“CNN”), implementing Row Stationary dataflow for processing the data received and outputting information based on the processed data required for generating the application's output or an intermediate computation result.

14. The method of claim 13, wherein said systolic array architecture comprises at least one macro array of processing elements, wherein each of said at least one macro array comprises a plurality of basic arrays of processing elements and wherein each of said plurality of basic arrays comprises a plurality of processing elements, each of said processing elements is a synchronous digital circuit, operated with a clock signal toggling at a pre-defined frequency, and said at least one macro array, said plurality of basic arrays and said plurality of processing elements are arranged in an layered hierarchical order.

15. The method of claim 14, wherein said plurality of processing elements comprising each at least one data register, at least one coefficient register, at least one control register, at least one multiplier and at least one adder, and wherein said method comprises a step of executing by said plurality of processing elements a part of the process for calculating convolutions in a CNN, depending on location of each respective processing elements within a corresponding basic array to which it belongs.

16. The method of claim 14, wherein at least one of said plurality of processing elements is adapted to output data belonging to more than one output channel, while reusing the same input data.

17. The method of claim 14, further comprising a step of providing said macro array with a cache memory for storing features' related data and coefficients' related data thereat.

18. A user device configured for carrying out a computer vision application, wherein said user device comprising at least one image sensor configured to convey data for generating information required for generating an image, and at least one computational module of claim 1 for processing the data conveyed from said at least one image sensor.
